(19) United States
(12) Patent Application Publication
(10) Pub. No.: US 2016/0268805 A1
(43) Pub. Date: Sep. 15, 2016

(54) Alternative Powering and Diagnosis of an Accessibility Lift

(71) Applicants: Kevin Michael Finn, Norwalk, CT (US); Gary Allen Coventry, Darien, CT (US)

(72) Inventors: Kevin Michael Finn, Norwalk, CT (US); Gary Allen Coventry, Darien, CT (US)

(21) Appl. No.: 15/065,370

(22) Filed: Mar. 9, 2016

Related U.S. Application Data
(60) Provisional application No. 62/130,033, filed on Mar. 9, 2015.

(51) Int. Cl. H02J 3/38; A61G 5/04; A61G 5/06; H02J 9/06; H02J 7/00

(52) U.S. Cl. CPC H02J 3/382; H02J 3/383; H02J 3/386; H02J 9/061; H02J 7/007; A61G 5/061; A61G 5/06; A61G 5/04

(57) ABSTRACT

An accessibility lift device that may use singular or multiple energy sources, including solar, wind, hydro, regenerative energy, in addition to or instead of conventional line power to provide users with greater equipment reliability and stability during a prolonged absence of one or more of the available energy sources. The accessibility lift device may be a stair lift or chair for stairs. Early prediction measures may be taken as to servicing needs based upon detected lift speed, motor current, battery storage levels, and appropriate alerts may be generated accordingly. Increasing alertable radius by means of wireless communications will allow lifts installed outdoors and in remote areas to be more closely monitored and maintained.

CROSS-REFERENCE TO COPENDING PATENT APPLICATIONS

The present application asserts priority as of the filing date of provisional patent application Ser. No. 62/130,033 filed Mar. 9, 2015.

### BACKGROUND OF THE INVENTION

1. Field of the Invention

The present invention relates to the area of assistive technology and durable medical equipment that may use singular or multiple energy sources, including solar, wind, hydro, regenerative energy, The assistive technology and durable medical equipment is preferably an accessibility lift, which provides access for people with disabilities to reach areas of a home or office or other areas that would not otherwise be readily accessible. An accessory lift is also referred to as a stair lift, a chair lift, a platform lift, a stair chair, a stair glider and a chair for stairs. An accessory lift may be understood to be motorized equipment that will climb up and down a staircase or vertically to address changes in elevation.

2. Description of the Related Art

Accessibility lifts are designed to provide access for people with disabilities to reach areas of a home or office or other areas that would not otherwise be readily accessible. Currently, these lifts are fully dependent on utility line power to either power lifts directly or to maintain charging on DC powered systems. During a brief or prolonged interruption of utility line power, these lifts may cease to operate, and even DC powered systems may experience permanent damage to depleted batteries, often requiring immediate and expensive service costs.

Current accessibility lift technology requires A.C. line utility power as the primary energy supply for direct power or for charging of DC lift batteries. Even in homes with typical solar power systems, when the grid power is interrupted, the solar powered system will shut itself down as well in order to protect against back-feeding dangerous voltages into the grid. Many lifts are now equipped with DC battery systems designed to work for a limited time during a power outage, providing only a limited number of trips before exhausting or compromising batteries. With most current lift systems, when charging power is disrupted or when lifts are off charging stations, the lift will sound an audible alert, notifying the user that charging availability has been interrupted and needs to be restored. Users must be of adequate hearing ability, and/or lift must be within user's audible range for these types of alert systems to be useful. State of battery condition is unknown with these current solutions, even when power is available. Battery failures can lead to distressed users with urgent servicing needs.

It is desired to provide an accessibility lift device that may use singular or multiple energy sources, including solar, wind, hydro, regenerative energy, in addition to or instead of conventional line power, thus providing a superior level of security and reliability with no impact to navigation or egress during power failures for those who are particularly dependent on the reliability of their accessibility equipment. Since these alternate power sources are naturally-occurring and renewable, related power costs to customers of such a lift system will be greatly reduced or even free. Further, by empowering dependent users with superior and future-adaptable diagnostic, security and control abilities pertaining to their lift, no matter where it may be installed including outdoors or remote areas of a home, they will be better prepared to identify and address potential lift failures before they occur.

### SUMMARY OF THE INVENTION

One aspect of the invention resides in a sustained operability of an accessibility lift in the absence of A.C. line utility power such as during a prolonged storm.

Another aspect is to provide a greater level of Independence and security to individuals who are particularly reliant on accessibility lift(s) for basic needs.

An additional aspect is to utilize both the charging energy sources and onboard battery storage as a means of providing energy to accessory devices such as cell phones, flashlights or other devices that may be desirable in emergency situations.

A further aspect is to provide battery state and other diagnostic security and control abilities including wireless monitoring which may be made available to user, concerned family members, or to an accessibility equipment technician or dealer, giving user a greater level of confidence when using the equipment.

An additional objective is to have an accessibility lift which can be readily installed where A.C. Line utility power is not readily or economically feasible such as outdoors, as with exterior entries or a park or other remote area.

To realize such aspects, the invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

For a better understanding of the present invention, reference is made to the following description and accompanying drawings, while the scope of the invention is set forth in the appended claims.

FIG. 1 is a schematic diagram of a Stair lift with Alternative energy source(s) and power controller and diagnostic features in accordance with the invention.

FIG. 2 is schematic diagram of a Platform/Wheelchair Lift with Alternative energy source(s) power controller and diagnostic features in accordance with the invention.

FIG. 3 is a schematic diagram of a typical DC lift charging circuit, but modified with a loss-of-charge alarm diode bypass and relocation of line power supply input in accordance with the invention.

FIG. 4 is a diagram of a diagnostic port that may be installed on lift for purposes of interchangeable and upgradable diagnostic modules including battery fuel gauges, accessory batteries and wireless diagnostic communication and wireless controls in accordance with the invention.

FIG. 5 is a diagram representing various components of lift that diagnostic port pins will be electrically connected to in accordance with the invention.

### DETAILED DESCRIPTION OF THE PREFERRED EMBODIMENT

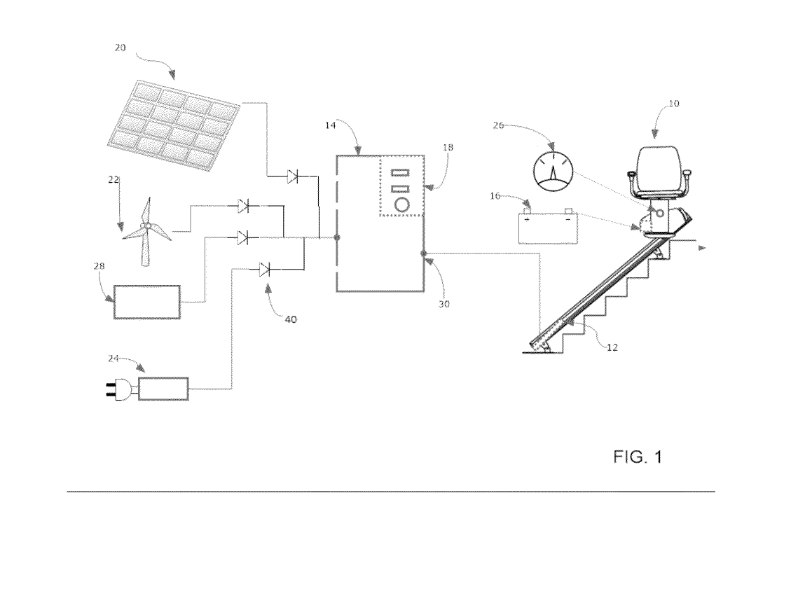

For purposes of this application, the phrase “accessory lift” is interchangeable with the term “lift” and is interchangeable with any of the terms: stair lift, chair lift, platform lift, stair chair, stair glider and chair for stairs. FIGS. 1-3 show various components. Unless otherwise indicated as to any modification, all the components depicted are conventional, although the particular circuit arrangement of the components with respect to each other is in accordance with the present invention.

FIG. 1 depicts a DC powered stair lift 10 containing battery storage 16 and is affixed to an inclined track 12, featuring charging contacts 42. A charge controller 14 (LMS 2420 PWM Controller or Renogy 20A PWM Dual Battery Controller may serve to exemplify) receives power from one or more of the following sources: a Solar PV panel 20, a wind generator 22, a line power supply 24, other alternative energy source 28. All power sources are individually diode-isolated 40, enabling the source with the greatest voltage output to provide charging current to the charge controller 14.

The charge controller 14 then delivers power from output 30 to track charging contacts 42 and optional power outputs 18 which may include USB, Automobile 12V Accessory Jack, Emergency Lighting, backup/auxiliary batteries, secondary accessibility Lift, additional accessibility or medical equipment (e.g. power wheel chairs, power scooters, oxygen concentrators.) These additional ports may be located on the charge controller itself or on the moving lift for greater user accessibility.

A Diagnostic Port 44 located on lift 10 may serve as a hub for direct-connection of diagnostic equipment and/or interchangeable diagnostic module(s) 26 which in one embodiment may provide charge status with low battery audible alert system, as exemplified by a DeltaPro BFG 24v Battery Fuel Gauge. The interchangeable nature of Diagnostic module 26 will allow the flexibility of customizable and future-adaptable lift diagnostic capabilities. These may include wireless communication and monitoring between lift and remote computers, smart phones and other electronic devices, security features and controls similar to those currently available for vehicles via the industry standard OBDII port.

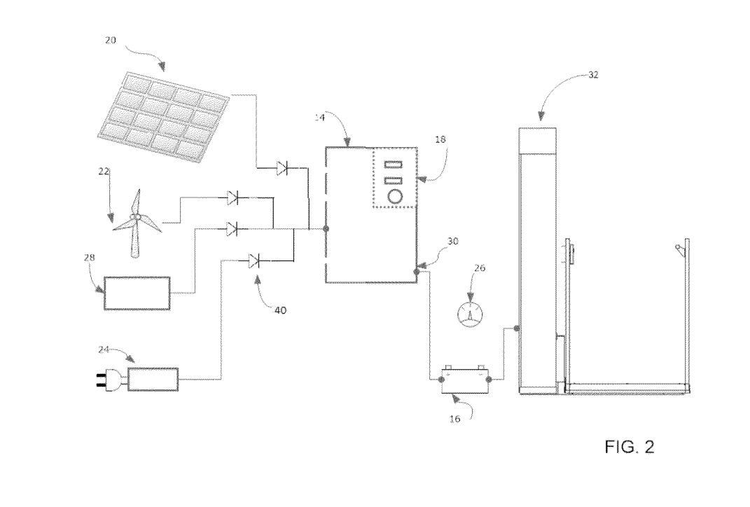

FIG. 2 depicts a DC powered Platform lift 32, A charge controller 14 (LMS 2420 PWM Controller or Renogy 20A PWM Dual Battery Controller may serve to exemplify) receives power from one or more of the following sources: a Solar PV panel 20, a wind generator 22, a line power supply 24, other alternative energy source 28. All power sources are individually diode-isolated 40, enabling the source with the greatest voltage output to provide charging current to the charge controller 14. The charge controller 14 then delivers power from output 30 to battery storage 16 and optional outputs 18 which may include USB, Automobile 12V Accessory Jack, Emergency Lighting, backup/auxiliary batteries, secondary accessibility Lift, additional accessibility or medical equipment (e.g. power wheel chairs, power scooters, oxygen concentrators.) These additional ports may be located on the charge controller itself or on the moving lift for greater user accessibility.

A Diagnostic Port 44 located on lift 32 may serve as a hub for direct-connection of diagnostic equipment and/or interchangeable diagnostic module(s) 26 which in one embodiment may provide charge status with low battery audible alert system, as exemplified by a DeltaPro BFG 24v Battery Fuel Gauge. The interchangeable nature of Diagnostic module 26 will allow the flexibility of customizable and future-adaptable lift diagnostic capabilities. These may include wireless communication and monitoring between lift and remote computers, smart phones and other electronic devices, security features and controls similar to those currently available for vehicles via the industry standard OBDII port.

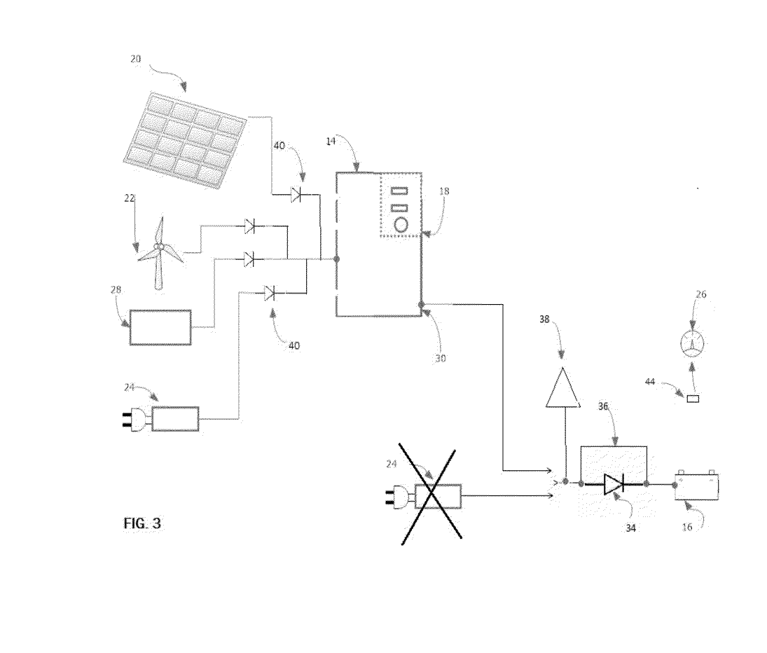

FIG. 3 depicts a conventional DC lift charging circuit, but modified to bypass existing loss-of-charge alarm diode. A line power supply 24 connects to lift battery 16 via diode(s) 34 located within the charging circuit, and charging alert system 36 which senses presence of incoming voltage and activates alert system when charging is not present. In this invention, diode(s) 34 is bypassed 36 or eliminated to enable charge controller 14 to sense battery conditions and provide appropriate charge current.

Line power supply 24 is moved to the input of the charge controller 14 via isolation diode 40 along with other charging sources also equipped with isolation diodes 40. However, the line power supply 24 could instead be eliminated (See “X” in FIG. 3) provided alternative sources of power are available. An additional function of bypassing diode(s) 34 is to prevent existing off-charge alert alarm 38 as exemplified by Kingstate KXG 1205C on some lift equipment from activating during inactive charging periods e.g. at night or overcast conditions in the case of solar-only-supplied charging.

A removable diagnostic module 26 (Deltavolt BFG24V Battery Fuel Gauge for example) connects to Diagnostic Port 44 may provide ongoing battery status, which may vary during fluctuations in available charging voltage and lift usage. Diagnostic Module 26 may incorporate a low battery alarm, which may be audible, visual, vibratory, wireless signal to remote device(s) including texting and/or email, or a combination thereof to accommodate a variety of lift locations, user limitations or owner preferences.

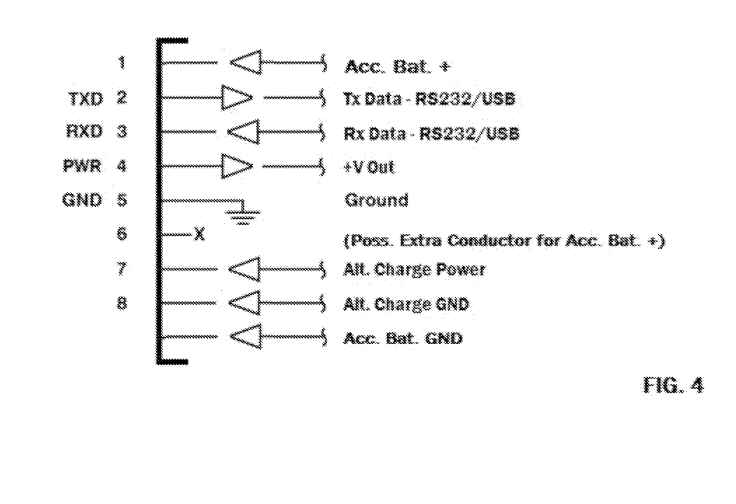

FIG. 4 depicts a suggested pin diagram detail of Diagnostic Module 44 which may provide the following diagnostic benefits: on board battery status, alternate charging port (RS232 or USB), Transmit and Receive to allow external modules to obtain/interrogate lift status' regarding battery state, lift safety sensor(s) status, motor currents, trip data and a means for connecting accessory batteries and provide a conduit for a wireless security key and lift control functions.

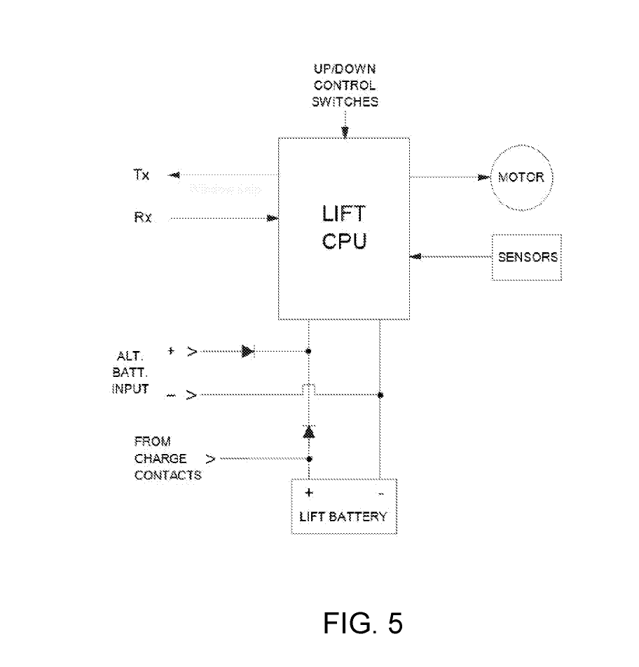

FIG. 5 depicts a diagram illustrating the internal lift components that will be connected to corresponding pins of Diagnostic Module 44. Tx pin will transmit data from the lift cpu to connected diagnostic equipment. Rx pin will receive interrogation commands from diagnostic equipment. +V Out will reflect lift's internal battery voltage status. Ground pin will connect to lift pcb ground. Acc. Battery (Alt. Batt.+in diagram) positive pin will connect to lift cpu and will utilize isolation diodes to prevent combining voltage with existing on-board battery. Acc. Battery (Alt. Batt.−in diagram) negative pin will connect to negative side of on-board battery. Alt. Charge+Positive pin will connect to positive side of on-board battery (battery side of isolation diode). Alt Charge GND pin will connect to −Negative side of on-board battery. Additional pins may be used for other purposes including extra conductors for accessory batteries to meet various current demands, or parallel connection to lift's security key circuit, which may allow for wireless enabling or disabling of lift. In this embodiment, the physical lift key would override any possible wireless functions.

While the foregoing description and drawings represent the preferred embodiments of the present invention, it will be understood that various changes and modifications may be made without departing from the scope of the present invention.

What is claimed is:

1. A method of powering a lift device, comprising:
accessing any one of a plurality of different energy sources, the different energy sources being selected from the group consisting of solar, wind, hydro, regenerative energy, auxiliary batteries, in addition to accessing conventional line power;
charging a lift device with power from at least one of the plurality of different energy sources as a result of the accessing;
connecting a line power supply to a lift battery via a diode within a direct current lift charging circuit;
sensing a presence and an absence of incoming voltage from the line power supply;
activating a charging alert circuit in response to the sensing of the absence of the incoming voltage from the line power supply;
bypassing the diode in response to the activated charging alert circuit to sense conditions of the lift battery; and
providing appropriate charge current to the lift battery from the at least one of the different energy sources via the bypassing.

2. The method of claim 1, wherein the bypassing prevents the charging alert circuit from activating during inactive charging periods.

3. The method of claim 1, further comprising:
providing ongoing battery status with a diagnostic module, the ongoing battery status varying during fluctuations in available charging voltage and lift usage.

4. The method of claim 3, wherein the diagnostic module incorporates a low battery alarm, the low battery alarm being selected from the group that is audible, visual, vibratory, and a combination thereof.

5. A conversion kit to retrofit a lift, comprising:
means for accessing any one of a plurality of different energy sources, the different energy sources being selected from the group consisting of solar, wind, hydro, regenerative energy, auxiliary batteries; and conventional line power; and
means for powering a lift device from at least one of the plurality of different energy sources via the means for accessing;
a connection configured to connect the line power supply to a lift battery via a diode within a direct current lift charging circuit;
a sensor configured to sense a presence and an absence of incoming voltage from the line power supply;
a charging alert circuit configured to activate in response to the sensor sensing the absence of the incoming voltage from the line power supply;
a bypass circuit responsive to the charging alert circuit being activated to bypass the diode for sensing conditions of the lift battery; and
means for providing appropriate charge current to the lift battery from the at least one of the plurality of different energy sources via the bypassing.

6. The conversion kit to retrofit a lift of claim 5, wherein the bypass circuit is configured to prevent the charging alert circuit from activating during inactive charging periods.

7. The conversion kit to retrofit a lift of claim 5, further comprising:
a diagnostic module configured to provide ongoing battery status, the ongoing battery status varying during fluctuations in available charging voltage and lift usage.

8. The conversion kit to retrofit a lift of claim 7, wherein the diagnostic module incorporates a low battery alarm, the low battery alarm being selected from the group that is audible, visual, vibratory, and a combination thereof.
